(19) United States
(12) Patent Application Publication
(10) Pub. No.: US 2007/0122642 A1
(43) Pub. Date: May 31, 2007

(54) Heat resistant sheet

(76) Inventors: Masanori Ogawa, Aichi (JP); Manabu Konishi, Aichi (JP); Tsuyoshi Watanabe, Aichi (JP)

Correspondence Address: Donald S Dowden;Cooper & Dunham, 1185 Avenue of the Americas, New York, NY, 10036, US

(21) Appl. No.: 10/587,464

(22) PCT Filed: Jan. 11, 2005
(86) PCT No.: PCT/JP05/00206

§ 371 Date: Jul. 25, 2006

(51) Int. Cl. B32B 27/42

(52) U.S. Cl. 428/524

(57) ABSTRACT

The object of the present invention is to provide a sheet having an excellent heat resistance. The heat resistant sheet of the present invention is prepared by forming a phenolic resin film(s) on one or both sides of a thermoplastic resin sheet. The phenolic resin film(s) can be formed by coating a phenolic resin water solution into which a water soluble polymer has been added onto one or both sides of the thermoplastic sheet, and then heating.

### FIELD OF THE INVENTION

The present invention relates to a thermoplastic resin sheet which can be used as a wrapping sheet, for car interiors, as a building material, and the like.

### BACKGROUND OF THE INVENTION

A thermoplastic resin sheet made of a thermoplastic resin, such as polyester or the like has been used as a wrapping sheet. For instance, the muffler of a car or motorbike is transported wrapped in a polyester sheet for protection.

### DISCLOSURE OF THE INVENTION

### Problem to be Solved by the Present Invention

Said thermoplastic resin sheet has a problem in that when it is used at a temperature higher than its softening point even for a short time, it melts and can not function as a wrapping sheet.

### The Means to Solve the Problem

In the present invention, to solve said problem, a heat resistant sheet consisting of a thermoplastic resin sheet on one or both sides of which a phenolic resin film(s) is (are) formed, is provided.

Said phenolic resin film is formed by coating a phenolic resin water solution into which a water soluble polymer has been added onto one or both sides of said thermoplastic resin sheet, and then heating.

### The Effect of the Invention

When said heat resistant sheet of the present invention is molded at a temperature several tens of degrees higher than that at which a thermoplastic resin sheet deforms, said heat resistant sheet does not melt, so that said heat resistant sheet can be molded into a desirable shape.

### PREFERRED EMBODIMENTS TO PRACTICE THE INVENTION

[Thermoplastic Sheet]

The thermoplastic resin used as the material for said thermoplastic resin sheet is such as polyethylene terephthalate (PET), polybutylene terephthalate (PBT), polyphenylene ether (PPE), modified polyphenylene ether (m-PPE), polycarbonate (PC), polystyrene (PS), polypropylene (PP), polyamide (PA), polyarylate (PAR), polyethylene (PE), acrylonitrile butadiene styrene polymer (ABS), polyacetal (POM), or the like. A polymer blend and polymer alloy containing two or more kinds of said thermoplastic resin may be used for said thermoplastic resin sheet of the present invention.

The thickness of said thermoplastic resin sheet used in the present invention may be in the range of between 0.01 mm and 1 mm, but preferably 0.02 mm and 0.5 mm, nevertheless, a thermoplastic resin sheet which is thinner than 0.2 mm can be used in the present invention. In a case where said thermoplastic resin sheet is thicker than 1 mm, said thermoplastic resin sheet can not be heat resistant even when said phenolic resin film is formed on the surface of said thermoplastic resin sheet.

Further, in a case where said thermoplastic resin sheet is thinner than 0.01 mm, the resulting sheet lacks strength.

Said thermoplastic resin sheet can be manufactured using a common method, such as the calendar method, extrusion method (T-die method), press method, and the like.

Further, other than said thermoplastic sheet manufactured using one of said methods, a nonwoven fabric sheet, knit or woven sheet, made of said thermoplastic resin may also be used as said thermoplastic sheet.

Phenolic resin films is (are) formed on one or both sides, and to improve the adhesiveness of said thermoplastic resin sheet to said film, surface treatments such as a primer treatment, flame treatment, sulfuric acid treatment, sand blast treatment, corona discharge treatment, or the like may be administered to one or both sides of said thermoplastic resin sheet.

[Phenolic Resin Film]

The phenolic resin used for said phenolic resin film of the present invention is a condensation polymer of a phenolic compound and aldehyde and/or an aldehyde donor.

(Phenolic Compound)

The phenolic compound used to produce said phenolic resin may be a monohydric phenol, or polyhydric phenol, or a mixture of monohydric phenol and polyhydric phenol, but in a case where only monohydric phenol is used, formaldehyde is apt to be emitted when or after said resin composition is cured, so that a polyhydric phenol or a mixture of monohydric phenol and polyhydric phenol is preferably used.

(Monohydric Phenol)

The monohydric phenols include alkyl phenols such as o-cresol, m-cresol, p-cresol, ethylphenol, isopropylphenol, xylenol, 3,5-xylenol, butylphenol, t-butylphenol, nonylphenol, or the like; monohydric phenol derivatives such as o-fluorophenol, m-fluorophenol, p-fluorophenol, o-chlorophenol, m-chlorophenol, p-chlorophenol, o-bromophenol, m-bromophenol, p-bromophenol, o-iodophenol, m-iodophenol, p-iodophenol, o-aminophenol, m-aminophenol, p-aminophenol, o-nitrophenol, m-nitrophenol, p-nitrophenol, 2,4-dinitrophenol, 2,4,6-trinitrophenol, or the like; monohydric phenols of polycyclic aromatic compounds such as naphthol, or the like. Each monohydric phenol can be used singly, or in a mixture thereof

(Polyhydric Phenol)

The polyhydric phenols mentioned above, include resorcin, alkylresorcin, pyrogallol, catechol, alkylcatechol, hydroquinone, alkylhydroquinone, phloroglucin, bisphenol, dihydroxynaphthalene, or the like. Each polyhydric phenol can be used singly, or in a mixture thereof. Resorcin and alkylresorcin are more suitable than other polyhydric phenols. Alkylresorcin, in particular, is the most suitable of polyhydric phenols, because it can react with aldehydes more rapidly than resorcin.

The alkylresorcins include 5-methylresorcin, 5-ethylresorcin, 5-propylresorcin, 5-n-butylresorcin, 4,5-dimethylresorcin, 2,5-dimethylresorcin, 4,5-diethylresorcin, 2,5-diethylresorcin, 4,5-dipropylresorcin, 2,5-dipropylresorcin, 4-methyl-5-ethylresorcin, 2-methyl-5-ethylresorcin, 2-methyl-5-propylresorcin, 2,4,5-trimethylresorcin, 2,4,5-triethylresorcin, or the like.

A polyhydric phenol mixture produced by the dry distillation of oil shale, which is produced in Estonia, is inexpensive, said polyhydric phenol mixture including 5-metylresorcin, along with many other kinds of alkylresorcin, is highly reactive, and makes said polyhydric phenol mixture an especially desirable raw polyphenol material for the present invention.

In the present invention, said phenolic compound and aldehyde and/or aldehyde donor (aldehydes) are condensed together. Said aldehyde donor refers to a compound or a mixture which emits aldehyde when said compound or said mixture decomposes. The aldehydes include formaldehyde, acetaldehyde, propionaldehyde, chloral, furfural, glyoxal, n-butylaldehyde, capronaldehyde, allylaldehyde, benzaldehyde, crotonaldehyde, acrolein, phenylacetaldehyde, o-tolualdehyde, salicylaldehyde, or the like. The aldehyde donors include paraformaldehyde, trioxane, hexamethylenetetramine, tetraoxymethylene, or the like.

(Method of Producing the Phenol Resins)

The phenol resins (the precondensation polymers) can be prepared using the usual method. The usual methods include method (a) comprising the condensation of a monohydric phenol and/or a polyhydric phenol and aldehydes; method (b) comprising the condensation of a precondensation polymer and a monohydric phenol and/or a polyhyrdric phenol, wherein said precondensation polymer comprises a monohydric phenol and aldehydes, and/or a polyhydric phenol and aldehydes; method (c) comprising the condensation of a precondensation polymer and a monohydric phenol and/or a polyhydric phenol, wherein said precondensation polymer comprises a monohydric phenol, a polyhydric phenol and aldehydes; method (d) comprising the condensation of a precondensation polymer consisting of a monohydric phenol and aldehydes, with a precondensation polymer consisting of a polyhydric phenol and aldehydes; and method (e) comprising the condensation of a precondensation polymer consisting of a monohydric phenol and aldehydes and/or precondensation polymers consisting of a polyhydric phenol and aldehydes, with a precondensation polymer consisting of a monohydric phenol and polyhydric phenol and aldehydes.

In the present invention, the desirable phenolic resin is phenol-alkylresorcin cocondensation polymer. Said phenol-alkylresorcin cocondensation polymer provides a water solution of said cocondensation polymer (pre-cocondensation polymer) having good stability, and being advantageous in that it can be stored for a longer time at room temperature, as compared with a condensate consisting of a phenol only (precondensation polymer).

The desirable method for producing said phenol-alkylresorcin condensation polymer is first to create a reaction between phenol and aldehyde to produce a phenolic precondensation polymer, and then to add alkylresorcin, and if desired, aldehyde, to said phenolic precondensation polymer to create a reaction.

To improve the stability of said phenolic resin, precondensation polymer, which is water soluble, it is preferable that said precondensation polymer be sulfomethylated and/or sulfimethylated.

(Sulfomethylation Agent)

The sulfomethylation agents used to improve the stability of the aqueous phenol resin precondensation polymers, include such as water soluble sulfites prepared by the reaction between sulfurous acid, bisulfurous acid, or metabisulfirous acid, and alkaline metals, trimethylamine, quaternary ammonium (e.g. benzyltrimethylammonium); and aldehyde adducts prepared by the reaction between said water soluble sulfites and aldehydes.

Said aldehyde adducts are prepared by the addition reaction between aldehydes and water soluble sulfites as mentioned above, wherein the aldehydes include formaldehyde, acetaldehyde, propionaldehyde, chloral, furfural, glyoxal, n-butylaldehyde, capronaldehyde, allylaldehyde, benzaldehyde, crotonaldehyde, acrolein, phenylacetaldehyde, o-tolualdehyde, salicylaldehyde, or the like. For example, hydroxymethane sulfonate, which is one of the aldehyde adducts, is prepared by the addition reaction between formaldehyde and sulfite.

(Sulfimethylation Agent)

The sulfimethylation agents used to improve the stability of the aqueous solution of phenol resin, precondensation polymers include alkaline metal sulfoxylates of aliphatic or aromatic aldehyde such as sodium formaldehyde sulfoxylate (a.k.a. Rongalit), sodium benzaldehyde sulfoxylate, or the like; hydrosulfites (a.k.a. dithionites) of alkaline metal or alkaline earth metal such as sodium hydrosulfite, magnesium hydrosulfite, or the like; hydroxyalkanesulfinate such as hydroxymethanesulfinate, or the like.

In the case of sulfomethylation and/or sulfimethylation, the sulfomethylation agents and/or sulfimethylation agents may be added to the precondensation polymers at an arbitrary time.

The addition of the sulfomethylation agents and/or sulfimethylation agents may be made any time, such as before, during, or after condensation.

(Third Component)

In the case of producing said phenol resins, if necessary, additives may be mixed in with said phenol resins as a catalyst, or to adjust their pH. Such additives include acidic compounds and alkaline compounds. Said acidic compounds include inorganic acid or organic acids such as hydrochloric acid, sulfuric acid, orthophosphoric acid, boric acid, oxalic acid, formic acid, acetic acid, butyric acid, benzenesulfonic acid, phenolsulfonic acid, p-toluenesulfonic acid, naphthalene-α-sulfonic acid, naphthalene-β-sulfonic acid, or the like; esters of organic acids such as dimethyl oxalate, or the like; acid anhydrides such as maleic anhydride, phthalic anhydride, or the like; salts of ammonium such as ammonium chloride, ammonium sulfate, ammonium nitrate, ammonium oxalate, ammonium acetate, ammonium phosphate, ammonium thiocyanate, ammonium imidosulfonate, or the like; halogenated organic compounds such as monochloroacetic acid, the salt thereof, organic halogenides such as α,α′-dichlorohydrin, or the like; hydrochlorides of amines such as triethanolamine hydrochloride, aniline hydrochloride, or the like; urea adducts such as the urea addict of salicylic acid, urea adduct of stearic acid, urea adduct of heptanoic acid, or the like; and N-trimethyltaurine, zinc chloride, ferric chloride, or the like; alkaline compounds including ammonia, amines; hydroxides of alkaline metal and alkaline earth metals such as sodium hydroxide, potassium hydroxide, barium hydroxide, calcium hydroxide, and the like; oxides of alkaline earth metal such as lime, or the like; salts of alkaline metals such as sodium carbonate, sodium sulfite, sodium acetate, sodium phosphate, or the like.

Further, if necessary, the phenol resins and/or precondensation polymers thereof may be cocondensed with amino resin monomers or precondensation polymers thereof. Said amino resin monomers include urea, thiourea, melamine, thiomelamine, dicyandiamine, guanidine, guanamine, acetoguanamine, benzoguanamine, 2,6-diamino-1,3-diamine, or the like.

Further, curing agents such as an aldehyde and/or an aldehyde donor or an alkylol triazine derivative, or the like, may be added to said phenolic resin precocondensation polymer.

As said aldehyde and/or aldehyde donor, the same aldehyde and/or aldehyde donor as used in the production of said phenolic precondensation polymer(including precocondensation polymer) is (are) used, and alkylol triazine derivatives are produced by the reaction between said urea group compound, amine group compound, and said aldehyde and/or aldehyde donor. Said urea group compound used in the production of said alkylol triazine derivatives may be such as urea, thiourea, and alkylurea such as methylurea, an alkylthiourea such as methylthiourea; phenylurea, naphthylurea, halogenated phenylurea, nitrated alkylurea, or the like, or a mixture of two or more kinds of said urea group compound. A particularly desirable urea group compound may be urea or thiourea. As the amine group compounds, aliphatic amine such as methylamine, ethylamine, propylamine, isopropylamine, butylamine, amylamine or the like, benzylamine, furfuryamine, ethanolamine, ethylenediamine, hexamethylenediamine hexamethylenetetramine, or the like, as well as ammonia are illustrated, and said amine group compound is used singly or in combination with two or more amine group compounds.

The aldehyde and/or aldehyde donor used for the production of said alkylol triazine derivative is (are) the same as the aldehyde and/or aldehyde donor used for the production of said phenolic precondensation polymer.

To synthesize said alkylol triazine derivatives, commonly 0.1 to 1.2 moles of said amine group compound(s) and/or ammonia, and 1.5 to 4.0 moles of said aldehyde and/or aldehyde donor are combined to react with 1 mole of said urea group compound.

In said reaction, the order in which said compounds are added is arbitrary, but preferably, the required amount of aldehyde and/or aldehyde donor is (are) first put into a reactor, following which the required amount of amine group compound(s) and/or ammonia is (are) gradually added to said aldehyde and/or aldehyde donor, the temperature being kept at below 60° C., after which the required amount of said urea group compound(s) is (are) added to the resulting mixture, then said mixture is agitated and heated at 80 to 90° C. for 2 to 3 hours so as to react together. Usually, 37% by mass of formalin is used as said aldehyde and/or aldehyde donor, but some of said formalin may be replaced with paraformaldehyde to increase the concentration of the reaction product.

Further, in a case where hexamethylenetetramine is used, the solid content of the reaction product obtained is much higher. The reaction between said urea group compound, said amine group compound and/or ammonia and said aldehyde and/or aldehyde donor is commonly performed in a water solution, but said water may be partially or wholly replaced by one or more kinds of alcohol such as methanol, ethanol, isopropanol, n-butanol, ethylene glycol, diethylene glycol, or the like, and one or more kinds of other water soluble solvent like a ketone group solvent such as acetone, ethyl methyl ketone, or the like can also be used as solvents.

The amount of said curing agent to be added is, in the case of an aldehyde and/or aldehyde donor, in the range of between 10 and 100 parts by mass to 100 parts by mass of said phenolic resin precondensation polymer (precocondensation polymer), and in the case of alkylol triazine, 10 to 500 parts by mass to 100 parts by mass of said phenolic resin precondensation polymer (precocondensation polymer).

Usually, said phenolic resin precondensation polymer of the present invention, is prepared as a water solution, but if desired, a water soluble organic solvent may be used. Said water soluble organic solvents include such as alcohol group solvents such as methanol, ethanol, n-propanol, isopropanol, n-butanol, isobutanol, sec-butanol, t-butanol, n-amyl alcohol, isoamyl alcohol, n-hexanol, methylamyl alcohol, 2-ethylbutanol, n-heptanol, n-octanol, trimethylnonyl alcohol, cyclohexanol, benzyl alcohol, furfuryl alcohol, tetrahydrofurfuryl alcohol, abiethyl alcohol, diacetone alcohol, or the like; ketone group solvents such as acetone, methylacetone, ethyl methyl ketone, methyl n-propyl ketone, methyl n-butyl ketone, isobutyl methyl ketone, diethyl ketone, di-n-propyl ketone, diisobutyl ketone, acetonylacetone, methyl oxide, cyclohexanone, methylcyclohexanone, acetophenone, camphor, or the like; glycol group solvents such as ethylene glycol, diethylene glycol, triethylene glycol, propylene glycol, trimethylene glycol, polyethylene glycol, or the like; glycol ether group solvents such as ethylene glycol monomethyl ether, ethylene glycol monoethyl ether, ethylene glycol isopropyl ether, diethylene glycol monomethyl ether, monomethyl triethylene glycol ether, or the like; esters of said glycol group solvents or derivatives thereof such as ethylene glycol diacetate, diethylene glycol monoethyl ether acetate, or the like; ether group solvents such as 1,4-dioxane, or the like; and further, diethyl cellosolve, diethylcarbitol, ethyl lactate, isopropyl lactate, diglycol diacetate, dimethyl formamide, or the like.

Further, to said phenolic resin precondensation polymer water solution, water-soluble polymer and natural gums such as polyvinyl alcohol, sodium alginate, starch, starch derivatives, glue, gelatin, blood powder, methylcellulose, carboxymethylcellulose, polyacrylate, polyacrylamide or the like; fillers and surfactants such as calcium carbonate, magnesium carbonate, barium sulfate, calcium sulfite, calcium phosphate, calcium hydroxide, magnesium hydroxide, aluminum hydroxide, magnesium oxide, titanium oxide, iron oxide, zinc oxide, alumina, silica, diatom earth, dolomite, gypsum, talc, clay, asbestos, mica, calcium silicate, bentonite, white carbon, carbon black, iron powder, aluminum powder, glass powder, stone powder, synthetic resin powder, blast furnace slag, fly ash, cement, zirconia powder, wood flour, wheat flour, walnut flour, coconut flour, ground rice, or the like; higher fatty acid such as stearic acid, palmitic acid, or the like; higher alcohol such as palmityl alcohol, stearyl alcohol, or the like; fatty acid ester such as butyl stearate, glycerol, monostearate or the like; fatty acid amide; natural wax such as carnauba wax, or the like; synthetic wax, pigment, dye, burning retardant, flame retardant, insecticide, antiseptic agent, age resister, ultraviolet absorber, fluorescent dye, surfactant, foaming agent, oil repellent agent, or the like may be added.

Said phenolic resin precondensation polymer water solution is coated on the surface of said thermoplastic resin sheet and heat dried.

As for the coating method of said phenolic resin precondensation polymer, water solution, well known methods such as the roll coater method, knife coater method, dipping method, spray method, or the like is applied. Said phenolic resin precondensation polymer coated on the surface of said thermoplastic resin sheet is then heated to put it at C-stage.

In a case where said phenolic resin film is formed on both sides of said thermoplastic resin sheet, said precondensation polymer water solution may be coated on both sides of said sheet simultaneously and heat dried to form said film, or said water solution may be coated on one side and then dried to form said film, and then said water solution may be coated on the other side and dried, to form said film.

The coating amount of said phenolic resin precondensation polymer water solution is desirably in the range of between 5 g/m² and 100 g/m² per side. In a case where the coating amount of said water solution is below 5 g/m², the heat resistance of the resulting heat resistant sheet may be poor, while in a case where the coating amount of said water solution is above 100 g/m², the moldability of the resulting heat resistant sheet may deteriorate.

As described above, said heat resistant sheet of the present invention can be manufactured by forming said phenolic resin film on the surface of said thermoplastic resin sheet. Said thermoplastic resin sheet of the present invention may not melt by heating at a temperature several tens degree higher than that of the thermal deformation temperature.

The present invention is explained by the EXAMPLES described below, but the scope of the present invention should not be limited to only these descriptions in the EXAMPLES.

### EXAMPLE 1

Forty parts by mass of a resol type sulfomethylated phenol-alkyl resorcin formaldehyde precondensation polymer (50% by mass solid content) and 60 parts by mass of polyvinyl alcohol (10% by mass solid content) were mixed together to prepare a phenolic resin solution, after which said solution was coated onto one or both sides of each thermoplastic resin sheet (thickness 0.05 mm respectively), said thermoplastic resin sheets each being made of polyethylene terephthalate (PET), polycarbonate (PC), modified polyphenylene ether (styrene-polyamide modified polyphenylene ether, m-PPE), polybutylene terephthalate (PBT), polyamide (PA), polyarylate (PAR). The coating amount of said precondensation polymer solution on each sheet was 14 g/m² as a solid per side of said sheet. Said precondensation polymer solution coated on each thermoplastic resin sheet was then dried at 140° C. for 10 minutes, to put said precondensation polymer at C-stage, and obtain a heat resistant sheet. On one or both sides of each sheet, said phenolic resin film was formed. The resulting heat resistant sheets were then each cut into test pieces (each test piece being 10×10 cm in size), and each test piece was left standing in an incubator for 30 minutes, to determine a temperature at which said test piece would deform and contract by more than 1%. The results are shown in Table 1.

### COMPARISON 1

As a COMPARISON to EXAMPLE 1, using each thermoplastic resin sheet without said phenolic resin film, the same determination as in EXAMPLE 1 was carried out and the results are also shown in Table 1.

TABLE 1

| | EXAMPLE 1 | | |
|---|---|---|---|
| Thermoplastic | Coating on one | Coating on both | COMPARISON 1 |
| resin sheet | side (° C.) | sides (° C.) | (° C.) |
| PET | 259 | 274 | 240 |
| PC | 159 | 167 | 145 |
| Modified PPE | 232 | 243 | 225 |
| PBT | 224 | 235 | 210 |
| PA | 227 | 237 | 215 |
| PAR | 183 | 195 | 175 |

Referring to Table 1; it is confirmed that each heat resistant sheet on one or both sides of which said phenolic resin film(s) was (were) formed has better heat resistance than each of the thermoplastic sheets of COMPARISON 1.

### EXAMPLE 2

Fifty parts by mass of a sulfimethylated phenol-alkyl resorcin-formaldehyde precondensation polymer (55% by mass solid content), 30 parts by mass of polyvinyl alcohol (8% by mass solid content), 15 parts by mass of starch, and five parts by mass of paraform aldehyde powder as a curing agent were mixed together to prepare a phenolic resin solution, and said solution was then coated onto one or both sides of thermoplastic resin sheets (thickness 6 mm), said thermoplastic resin sheets each being made of polystyrene (PS), polypropylene (PP), polyethylene (PE), acrylonitrile butadiene styrene polymer (ABS), polyacetal (POM).

The coating amount of said precondensation polymer solution was 14 g/m² as a solid per side. Said precondensation polymer solution coated on each thermoplastic resin sheet was then left standing at 25 to 35° C. for 24 hours, to cure and put said phenolic resin at C-stage, and obtain a heat resistant sheet on one or both sides of which said phenolic resin film(s) was (were) formed. The same heat resistance test as in EXAMPLE 1 was carried out for each heat resistant sheet. The results are shown in Table 2.

### COMPARISON 2

As a COMPARISON to EXAMPLE 2 using each thermoplastic resin sheet without said phenolic resin film, the same determination as in EXAMPLE 2 was carried out and the results are also shown in Table 2.

TABLE 2

| | EXAMPLE 2 | | |
|---|---|---|---|
| Thermoplastic | Coating on | Coating on | COMPARISO 2 |
| resin sheet | one side (° C.) | both sides (° C.) | (° C.) |
| PS | 94 | 101 | 83 |
| PP | 125 | 136 | 117 |
| PE | 117 | 128 | 109 |
| ABS | 92 | 108 | 87 |
| POM | 147 | 159 | 136 |

Referring to Table 2, it is confirmed that each heat resistant sheet on one or both sides of which send phenolic resin film(s) was (were) formed has better heat resistance than each of the thermoplastic sheets of COMPARISON 2.

### EXAMPLE 3

Seventy parts by mass of a resol type sulfomethylated phenolalkyl resorcin-formaldehyde precondensation polymer (50% by mass solid content) and 30 parts by mass of water were mixed together to prepare a phenolic resin solution, then said solution was impregnated into a base sheet (thickness 0.4 mm) made of a nonwoven fabric of spun bonded polyester fibers (unit weight 40 g/m) on one side of which a polyethylene sheet was laminated, the amount of said precondensation polymer to be impregnated therein being set to be 30% by mass solid content, following which said base sheet into which said solution was impregnated, was then heated at 160° C. for 5 minutes, to cure and put said phenolic resin at C-stage, and prepare a heat resistant sheet.

A car muffler was covered with the resulting heat resistant sheet, the polyester fiber side of said heat resistant sheet coming into contact with said muffler.

Said muffler, covered with said heat resistant sheet, was protected from dirt, such as rain water, dust, and the like during transportation.

Adjustments of the engine of the car in which said muffler, covered with said heat resistant sheet was installed, were carried out. The engine was operated for about 10 minutes, after which no trouble regarding said heat resistant sheet was recognized. The temperature of said muffler during the operation of the engine was driven was 260° C.

### COMPARISON 3

Said base sheet, without having been impregnated with said solution was used in the same test as EXAMPLE 3, which was carried out by covering the muffler with said base sheet, and then driving the engine. After one minute of engine operation, said base sheet contracted and melted, and a part of said base sheet peeled from or stuck to the muffler.

### EXAMPLE 4

Sixty-five parts by mass of a sulfomethylated phenol-alkylresorcin-formaldehyde precondensation polymer (50% by mass solid content), 23 parts by mass of polyvinylalcohol (10% by mass solid content), 10 parts by mass of starch (20% by mass solid content), one part by mass of methyl alcohol, 0.5 part by mass of a phenolic age resister and 0.5 part by mass of an antifoaming agent of a nonionic surface active agent were mixed together to prepare a phenolic resin solution, after which said solution was coated on both sides of a PET sheet, the coating amount of said precondensation polymer being 40 g/m² as a solid per side, following which said PET sheet onto which said solution was coated, was then heated at 150° C. for 7minutes, to cure and put said phenolic resin at C-stage, and prepare a heat resistant sheet. Said sheet onto which said phenolic resin film was formed, was then cut into test pieces (10×10 cm size), and said test pieces then were left standing in an incubator at 230° C. for three days and seven days, and after left standing the condition of each of the test pieces were observed. The results were shown in Table 3.

### COMPARISON 4

Other than using the PCT sheet as it is, the same observations as in EXAMPLE 4 were carried out after having left said PCT sheets standing. The results are shown in Table 3.

TABLE 3

| | Days left standing (at 230° C.) | |
|---|---|---|
| TEST | 3 days | 7 days |
| EXAMPLE 4 | No warp no contraction | No warp no contraction |
| COMPARISON 4 | A slight contraction | Crack in the surface |

Referring to the results of EXAMPLE 4 and COMPARISON 4, it is recognized that no trouble was observed even when said test piece was exposed to a high temperature, around that of the temperature at which the thermal deformation of said thermoplastic resin sheet occurs.

### POSSIBILITY OF INDUSTRIAL USE

The heat resistant sheet of the present invention can be used as a wrapping sheet, for car interiors, as a building material, or the like.

1. A heat resistant sheet consisting of a thermoplastic resin sheet on one or both sides of which a phenolic resin film(s) is (are) formed.

2. A heat resistant sheet in accordance with claim 1, wherein said phenolic resin film is formed by coating a phenolic resin water solution into which a water soluble polymer has been added onto one or both sides of said thermoplastic resin sheet, and then heating.
